(19) United States
(12) Patent Application Publication
(10) Pub. No.: US 2008/0106434 A1
(43) Pub. Date: May 8, 2008

(54) Data collection system and method for collecting utility consumption data

(75) Inventor: Dan Winter, Pardesia (IL)

Correspondence Address: Martin D. Moynihan;PRTSI, Inc., P.O. Box 16446, Arlington, VA, 22215, US

(73) Assignee: Arad Measuring Technologies Ltd., Yokneam (IL)

(21) Appl. No.: 11/582,407

(22) Filed: Oct. 18, 2006

(51) Int. Cl. G08B 29/00

(52) U.S. Cl. 340/870.2

(57) ABSTRACT

A system and method for collecting, at a central station, utility consumption data from a plurality of sites, by a meter unit and a booster unit for each site. The meter unit includes a measuring device for measuring the utility consumption at the respective site; a storage device for storing the measured utility consumption during successive relatively-short time intervals; and a short-range transceiver. This booster unit includes a short-range transceiver for communication with the short-range transceiver of the meter unit at the respective site via a short-range transmission channel; and a long-range transmitter for transmitting utility consumption data to the central station via a long-range transmission channel. The system further includes a control system periodically activating the booster unit from a relatively long sleep state, to a relatively short active state during which the booster unit receives from its respective meter unit, via the short-range transmission channel, the utility consumption data stored therein during the preceding sleep state of the booster unit; and transmits the received utility consumption data to the central station via the long-range transmission channel.

### FIELD AND BACKGROUND OF THE INVENTION

The present invention relates to a data collection system and method for collecting, at a central station, utility consumption data from a plurality of consumption sites.

The consumption of various types of utilities, such as water, electricity, oil and gas, is commonly measured by utility meters located at the respective consumption sites. Individually reading such utility meters is time-consuming, labor-intensive and expensive, and therefore many meter reading systems have been devised to permit automatic reading. For example as described in U.S. Pat. No. 6,819,292, a common technique is to incorporate a transponder in the utility meter which can be activated, as and when desired, in order to transmit the meter reading via a wireless short-range channel to a mobile reading unit, which may subsequently transfer the information to a central station via a long-range transmission channel or the telephone line. Another technique in use is to transmit the information from each utility meter directly to the central station at periodic intervals.

It is important for the central station to receive the utility consumption data measured by the various utility meters for relatively short time intervals. This enables the central station to better track the fluctuations in demand, particularly to locate leaks in the distribution system. For example, if the flow rate of the utility at one particular site should be equal to the sum of the flow rates at two or more particular sites in the absence of leakage, a large disparity in the flow rates at the respective sites would indicate the presence of a leakage.

Better tracking of flow rates at the various consumption sites can, of course, be effected by frequent transmissions of utility consumption data from the respective consumption sites to the central station. However, the data transmissions from the consumption site are generally powered by electrical batteries. Accordingly, the power drain on such batteries, and therefore the need for recharging or replacement, depends to a great extent on the frequency at which this data is transmitted to the central station.

### OBJECT AND BRIEF SUMMARY OF THE PRESENT INVENTION

A broad object of the present invention is to provide a data collection system and method for collecting, at a central station, utility consumption date from a plurality of consumption sites, which system and method have a number of important advantages in the above respects.

According to one aspect of the present invention, there is provided a data collection system for collecting, at a central station, utility consumption data from a plurality of consumption sites, comprising:

a meter unit for each site, including: a measuring device for measuring the utility consumption at the respective site; a storage device for storing the measured utility consumption during successive relatively-short time intervals; and a short-range transceiver;

a booster unit for each consumption site, including: a short-range transceiver for communication with the short-range transceiver of the meter unit at the respective site via a short-range transmission channel; and a long-range transmitter for transmitting utility consumption data to the central station via a long-range transmission channel; and

a control system periodically activating the booster unit from a relatively long sleep state, to a relatively short active state during which the booster unit: receives from its respective meter unit, via the short-range transmission channel, the utility consumption data stored therein during the preceding sleep state of the booster unit; and transmits the received utility consumption data to the central station via the long-range transmission channel.

According to another aspect of the present invention, there is provided a method of collecting, at a central station, utility consumption data from a plurality of consumption sites, comprising: measuring the utility consumption in a meter unit at each site; storing in the meter unit the utility consumption measured during a plurality of successive, relative-short time intervals; and periodically activating a booster unit at the respective site, normally in a sleep state, to an active state during which the booster unit receives from the respective meter unit, via a short-range transmission channel, the utility consumption data stored in the meter unit during the preceding sleep state of the booster unit, and transmits the received utility consumption data to the central station via the long-range transmission channel.

In the described preferred embodiments, each sleep state of the booster unit is many orders of magnitude larger than each active state such as to enable the use of batteries requiring less frequent replacement or recharging, while still providing the central station with utility consumption data for relatively-short time intervals to enable better tracking of the utility consumption at the various sites.

According to another feature in the described preferred embodiments, the long-range transmitter of the booster unit is a frequency-hopping spread-spectrum transmitter such as to reduce the possibility of interference with respect to other transmissions.

According to a further feature in the described preferred embodiments, the short-range transceiver of the meter unit is a transponder which transmits its utility consumption data via the short-range transmission channel to the booster unit in response to an interrogating signal transmitted by the booster unit to the meter unit via the short-range transmission channel at the start of each active state of the booster unit.

In the described preferred embodiments, each of the relatively-short time intervals during which the measured utility consumption is stored in the storage device is measured in minutes (15 minutes in the described example), and each of the sleep states of the booster unit is measured in hours (four hours in the described example), such that during each active state of the booster unit, it receives from the meter unit via the short-range transmission channel a large number of readings (16 readings in the described example), and transmits them via the long-range transmission channel to the central station.

In a described embodiment, each of the meter units further includes a short-range transmitter activated at successive time intervals of very short duration for transmitting measured utility consumption data to mobile receivers via a short-range transmission channel. In this embodiment, the successive time intervals of very short duration are measured in seconds, the successive relatively-short time intervals are measured in minutes, the sleep state of the booster unit is measured in hours, and the active state of the booster unit is measured in seconds or fractions of a second.

A modification is described, wherein the short-range transceiver of the meter unit is a transponder which transmits its utility consumption data via the short-range transmission channel to the booster unit, or to a mobile unit, in response to an interrogating signal transmitted by the booster unit or mobile unit to the meter unit via the short-range transmission channel.

According to further features in the described preferred embodiment, each meter unit is enclosed within a housing constructed to be included in a pit hole in the ground, and each booster unit is located on a removable lid for the housing of its respective booster unit.

As will be more particularly described below, the data-collection system and method described permits relatively close monitoring of flow rates at various consumption sites, while at the same time minimizes the possibility of interference by other transmissions, and also increases the useful life of the batteries used in the system before replacement or recharging is required. A further advantage in the data-collection system described is that it readily permits upgrading of existing systems with minimum modification of the existing system, by merely providing the existing system with a booster unit and controls therefore as described more particularly below.

Further features and advantages of the invention will be apparent from the description below.

### BRIEF DESCRIPTION OF THE DRAWINGS

The invention is herein described, by way of example only, with reference to the accompanying drawings, wherein:

FIG. 1 is a block diagram of a data-collection system constructed in accordance with the present invention for collecting, at a central station, utility consumption data from a plurality of consumption sites;

FIG. 2 is a block diagram illustrating a meter reading installation at one of the consumption sites in the system of FIG. 1;

FIG. 3 illustrates the meter unit and the booster unit in the installation of FIG. 2 at one of the consumption sites;

FIG. 4 is a top plan view of FIG. 3;

FIG. 5 is an enlarged fragmentary view of the meter unit and booster unit illustrated in FIG. 3;

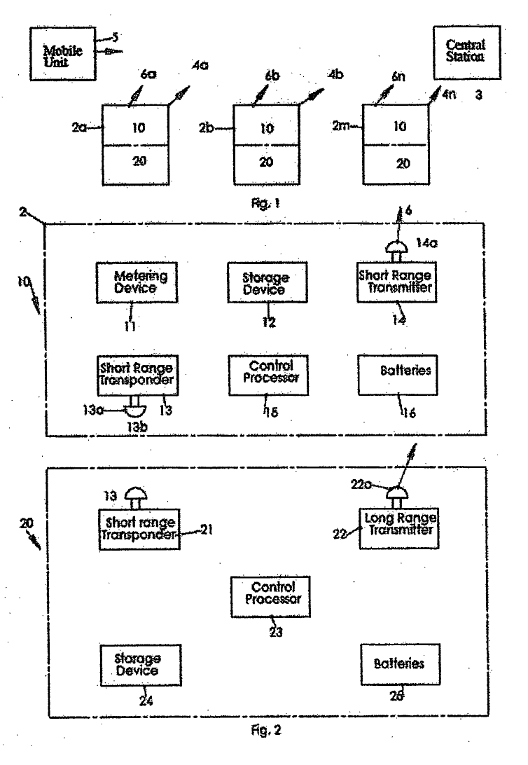

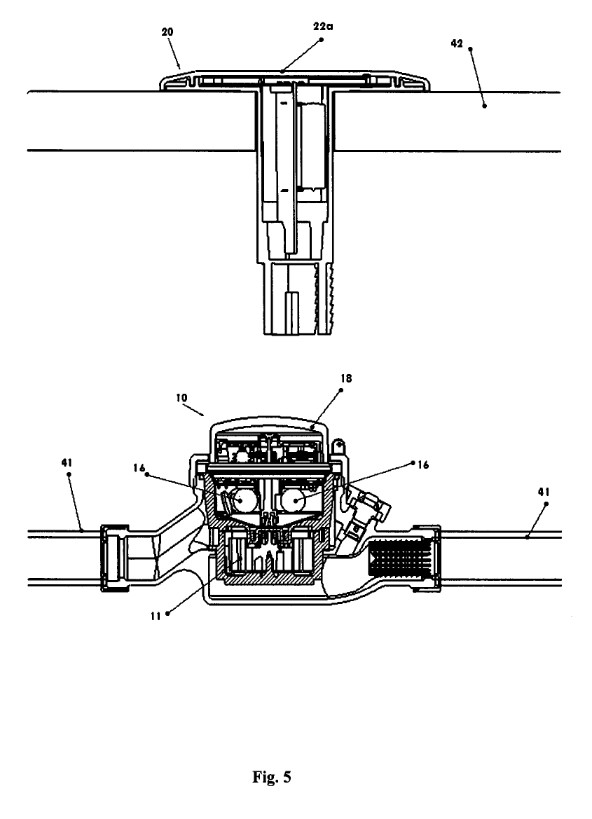

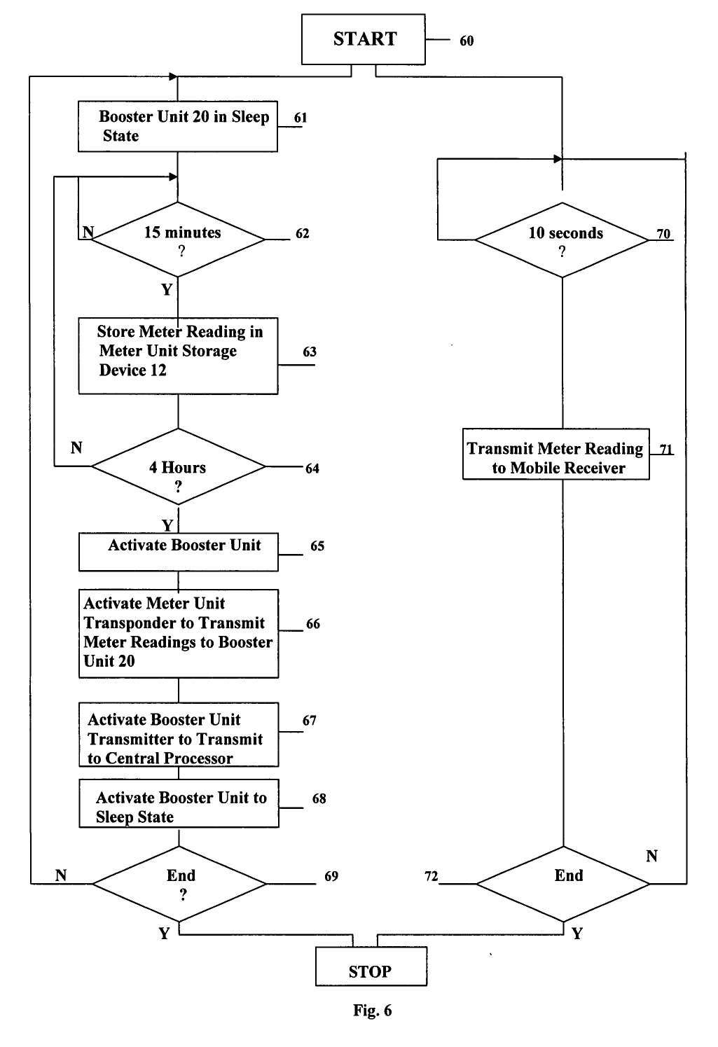

and FIG. 6 is a flow chart illustrating the overall operation of the data-collection system of FIGS. 1-5.

It is to be understood that the foregoing drawings, and the description below, are provided primarily for purposes of facilitating understanding the conceptual aspects of the invention and possible embodiments thereof, including what is presently considered to be a preferred embodiment. In the interest of clarity and brevity, no attempt is made to provide more details than necessary to enable one skilled in the art, using routine skill and design, to understand and practice the described invention. It is to be further understood that the embodiments described are for purposes of example only, and that the invention is capable of being embodied in other forms and applications than described herein.

### DESCRIPTION OF A PREFERRED EMBODIMENT

### Overall System

FIGS. 1 and 2 illustrate, in block diagram form, one form of data collection system constructed in accordance with the present invention for collecting, at a central station, utility consumption data from a plurality of consumption sites. FIG. 1 illustrates the overall system, whereas FIG. 2 illustrates the installation at each of the consumption sites in FIG. 1.

Thus, as shown in FIG. 1, the illustrated data collection system includes a plurality of meter-reading installations 2a, 2b - - - 2n at a plurality of utility consumption sites for measuring the utility consumption at the respective site and for transmitting utility consumption data to a remotely-located central station 3 via a long-range wireless transmission channel 4a-4n. Each installation 2a-2n also transmits the utility consumption data at the respective site to a mobile or drive-by receiver 5 via a short-range wireless transmission channel 6a-6n, respectively. The utility consumption being measured at each site may be that of water, electricity, gas, oil, or any other utility.

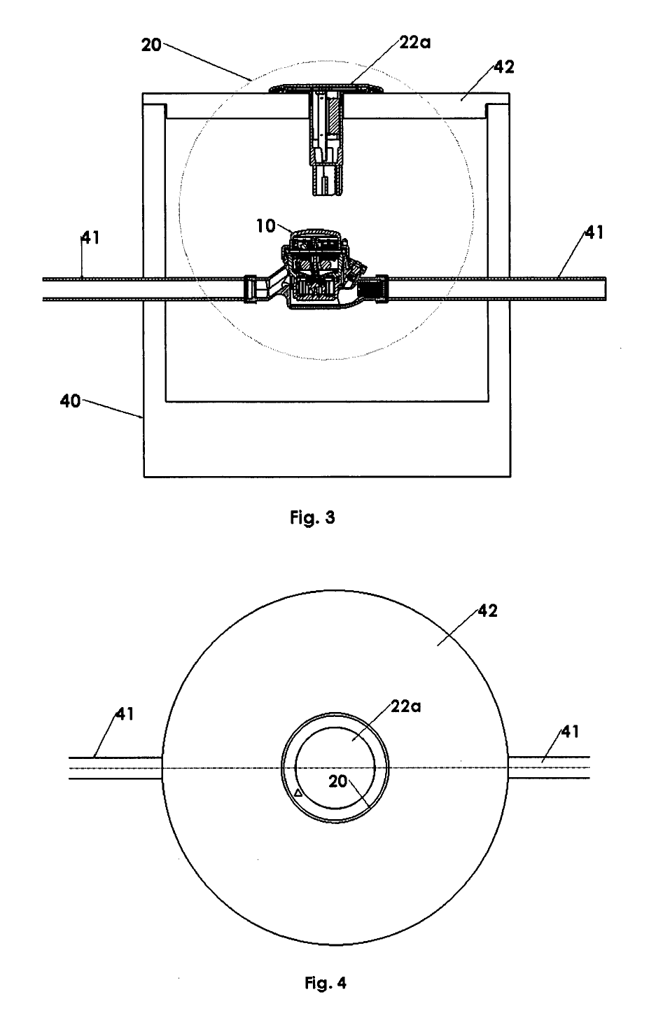

Each meter-reading installation 2a-2n in FIG. 1 is shown in block-diagram form at 2 in FIG. 2, and in physical construction form in FIG. 3. As shown in FIGS. 2 and 3, each meter-reading installation 2 includes a meter unit, generally designated 10, and a booster unit, generally designated 20. As will be described more particularly below, each meter unit measures the utility consumption at the respective site, and stores the measured utility consumption during successive time intervals of relatively short duration, e.g. 15 minutes.

The booster unit 20 at the respective site is normally in a sleep state. However, it is periodically activated to an active state during which it receives, via a short-range wireless transmission channel between the two units at the respective site, the utility consumption measured by the meter unit during the sleep state of the booster unit, and transmits the measured consumer utility data to the remotely-located central station 3 via the long-range wireless transmission channel 4 of the respective installation. In addition, the meter unit 10 at the respective installation also transmits, during successive time intervals of very short duration (e.g. every 10 seconds), the measured utility consumption data via the short-range wireless transmission channel 6 for reception by the mobile (drive-by) receiver 5.

As will be more particularly described below, the central station 3 thus receives, from each meter-reading installation 2, data regarding the utility consumption at the respective installation for each of a plurality of relatively short intervals (15 minutes in the example described) so that the central station is better capable of tracking the utility consumption rate at each site, and therefore, of better controlling the distribution of the utility within the system, locating leaks, etc. On the other hand, since the main power consumption results from the long-range transmission of the utility consumption data to the remotely-located central station, and since the long-range transmission is effected only during the active state of the booster unit (which may be a fraction of a second for each four hours in the described example), the power consumption at each installation is substantially reduced, thereby substantially increasing the useful life of the batteries used at such installations before replacement or recharging is required.

### The Meter Unit 10

As shown in FIG. 2, each meter unit 10 includes a metering device 11 for measuring the utility consumption at the respective site; and a storage device 12 for storing the measured utility consumption during successive time intervals of relatively short duration. These time intervals would be measured in minutes, or in fractions of an hour, being about 15 minutes in the described example. The utility consumption measurements during such relatively short time intervals (e.g., 15 minutes) are ultimately communicated to the central station 3 via the booster unit 20 at the respective site.

For this purpose, each meter unit 10 further includes a short-range transceiver 13 and antenna 13a. Since the booster unit 20 is located relatively close to its meter unit 10, this communication of the utility consumption measurement is via a short-range wireless transmission channel, shown at 13b in FIG. 2, and requires very little power.

Each meter unit 10 further includes a short-range transmitter 14 and antenna 14a for transmitting the utility consumption measurements to the mobile receiver 5 via the wireless transmission channel 6. These transmissions are preferable effected at successive time intervals of very short duration, measured in seconds, e.g. each 10 seconds, so as to assure reception by the mobile receiver 5 whenever passing by the respective installation. Since transmission channel 6 to the mobile receiver 5 is also of very short range, relatively little power is consumed in making these transmissions.

FIG. 2 illustrates meter unit 10 as including two separate short-range transmitters, namely transmitter 13 communicating with booster unit 20 at the respective site, and transmitter 14 communicating with the mobile receiver 5. Since the two transmitters are separately controlled, they are shown in FIG. 1 as separate elements. It will be appreciated, as described below, that a single transmitter could be provided for both functions but separately controlled for each respective function.

### The Booster Unit 20

The large power consumption in each of the meter reading installations 2 results primarily from the long-range wireless transmissions to the remotely-located central station 3 via the long-range wireless transmission channels 4a - - - 4n. These transmissions are produced, not by the meter unit 10 of the respective installation, but rather by the booster unit 20 in the respective installation. These long-range transmissions are effected in very short transmission time periods, each preferably less than a second. Each such transmission is for a utility measuring interval of relatively long duration, preferably measured in hours (e.g. four hours in the described example), thereby minimizing the power requirement for the respective transmissions.

Thus, as shown in FIG. 2, each booster unit 20 includes a short-range transceiver 21 having an antenna 21a in communication with the short-range transceiver 13 in the meter unit 10 at the respective installation. Preferably, transceiver 13 in meter unit 10 is a transponder which, when receiving an interrogating signal from transceiver 21 in booster unit 20, responds by transmitting the measured utility consumption data as stored in its respective storage device 12. As indicated earlier, since antenna 21a of booster unit 20 is located relatively close to antenna 13a of meter unit 10 (e.g., less than a meter) very little power consumption is involved in making these transmissions via the short-range wireless transmission channel 13b.

Each booster unit 20 further includes a long-range transmitter 22 having an antenna 22a communicating with the remotely-located central station 3 via a long-range wireless transmission channel 4. Preferably, this communication is effected by frequency-hopping spread-spectrum (FHSS) transmissions. Such transmissions are well know for minimizing interference, by randomly hopping the data signals across a number of defined frequency channels.

Each booster unit 20 further includes a control processor 23 which periodically activates the booster unit from a relatively long sleep state to a relatively short active state. During this active state, the booster unit receives, via the short-range transmission channel 13b, the utility consumption data stored in storage device 12 of its respective meter unit 10 during the preceding sleep state of the booster unit, and transmits the received utility consumption data to the central station 3 via the long-range transmission channel 4. In the example described below, the sleep state of the booster unit is many orders of magnitude larger than each active state, such that very little power is required for each long-range transmission.

Preferably, short-range transceiver 13 in meter unit 10 is a transponder which transmits its utility consumption data via the short-range transmission channel 13b to short-range transceiver 21 in booster unit 20 in response to an interrogating signal from the booster unit to the meter unit via the short-range transmission channel 13b at the initiation of each active state of the booster unit by its control processor 23.

Thus, meter unit 10 stores, in its storage device 12, the meter reading at the end of each predetermined interval, e.g. 15 minutes, while the booster unit 20 is in its normal sleep state. After a predetermined time interval, e.g. four hours, during which the meter unit has stored (e.g. 16) meter readings (i.e. a meter reading every 15 minutes for four hours), processor 23 activates booster unit 20 to an active state for sufficient time (usually less than 1 second) for (1) the short-wave transceiver 21 of the booster unit to transmit an interrogating signal to transponder 13 of meter unit 10; (2) the meter unit to transmit a response including the utility consumption data stored in its storage device for the preceding sleep period (four hours); and (3) the long-range transmitter 22 of booster unit 20 to transmit this data via the long-range transmission channel 4 to the central station 3.

Since the main power consumption of the booster unit is during its active state, and since its active state is for a time period smaller by several orders of magnitude than the time period of its sleep state, it will be appreciated that the power requirements for booster 20 are very small. Accordingly, the power drain on battery 25 of booster unit 20, is relatively small, thereby substantially increasing the useful life of the batteries before replacement or recharging is required.

As indicated earlier, the transmission of the utility consumption data by the long-range transmitter 22 of the booster unit 20 to the central station 3 is effected by a frequency-hopping spread-spectrum (FHSS) transmission channel 4 to reduce the possibility of interference with respect to other transmissions.

### An Example of a Physical Implementation

FIGS. 3-5 illustrate an example of the physical construction of a typical meter-reading installation 2 at each of the consumption sites. As shown particularly in FIG. 3, the meter unit 10 of the respective installation is housed within a housing 40 to be introduced into a pit hole in the ground at the installation site and connected to the line 41 supplying the utility (e.g. water, gas, oil, etc,) being measured. Housing 40 includes a removable lid 42 at its upper end to provide access to the meter unit 10 within the housing. Preferably, the booster unit 20 for the respective installation 2 is carried by a lid 42 of housing 40, with the various elements of the booster unit (e.g. long-range transceiver 21, long-range transmitter 22, control processor 23, storage device 24 and batteries 25) all located on or within lid 42. The antenna 22a of the long-range transmitter 22 is located externally of the housing for transmitting the utility consumption data to the remotely-located central station 3 via the long-range FHSS transmission channel 4.

Meter unit 10, and particularly the metering device 11 within that unit, may be of any known construction. Preferably, it is of the construction described in our prior U.S. Pat. No. 6,819,292, the contents of which are incorporated herein by reference. It includes, besides the metering device 11 for measuring the utility consumption at the respective site, an electronic system, schematically shown at 17, including the storage device 12, short-range transceiver 13, short-range transmitter 14, control processor 15, and battery 16. Meter unit 10 also includes a transparent window 18 to permit visually reading the measured utility consumption.

### Overall Operation

The operation of the illustrated data collection system will be apparent from the above description and from the flow chart of FIG. 6.

Thus, as shown in blocks 60-63 in FIG. 6, at each consumption site, while the booster unit 20 is in a sleep state, the utility consumption is measured by metering device 11 of the respective meter unit 10 during successive time intervals of relatively short duration, e.g. 15 minutes in the illustrated example. The measurement at each such interval is stored in storage device 12 of the meter unit 10. Accordingly, over a period of four hours, 16 measurements of utility consumption will be stored in storage device 12.

Periodically (every four hours in this example), control processor 23 activates the booster unit 20 from its normal sleep state to an active state (blocks 64, 65) for a relatively short period of time, about one second or less in this example. During its active state, the short-range transceiver 21 of the booster unit transmits an interrogation to transponder 13 of the respective meter unit. Transponder 13 responds by transmitting, via the short-range transmission channel 13b, the utility consumption measured for each of the short-duration time intervals (e.g. 15 minutes) stored in storage device 12 of meter unit 10 during the sleep interval of its respective booster unit (block 66). Thus, in the described example, booster unit 20 will receive, when in its active state at the end of each four hour interval, the 16 previous readings as measured by metering device 11 and stored in the respective storage device 12.

During the active state of the booster unit, its control processor 23 activates the long-range transmitter 22 of the booster unit to transmit the previous 16 readings received from the meter unit 10 to the remotely-located central station 3 via the long-distance FHSS transmission channel 4 (block 67).

The active state of the booster unit needs to be only sufficiently long to perform the foregoing functions, which can be performed in less than a second. As soon as these functions are performed, the booster unit then returns to its normal sleep state (block 68).

It will thus be seen that the central station 3 receives, from all the consumption sites, data concerning the utility consumption at each site for each of a plurality of relatively short time periods, e.g. 15 minutes in the described example. This enables the central station to keep close track of the rate of consumption at each of the consumption sites, and thereby enables it to better redistribute loads if necessary, to locate leakages, etc. On the other hand, since the large power drain in the communication system involved in the long-range transmission of the utility consumption data to the central station 3 occurs only during the active state of the booster unit 20, which is very short (e.g. seconds or less), the life of the batteries used in the system is substantially increased, thereby reducing the need for frequent replacement or recharging.

It will thus be seen that each meter reading installation 2a - - - 2n (FIG. 1) provides the central station 3 with 15 minute meter readings via the respective booster unit 20 and the long-range transmission channel 4.

As shown in blocks 70-72, FIG. 6, each meter reading installation also transmits the meter readings at 10 second intervals via the short-range transmission channels 6a - - - 6n for reception by a mobile receiver, such as a drive-by receiver.

### Some Possible Variations

It will be appreciated that many variations may be made in the described system. For example, the transponder 13 in each meter unit 10 could also serve as the short-range transmitter 14 of the respective unit for transmitting to the mobile receiver 5. This can be done by merely controlling the transmissions via the short-range transmission channels 6a - - - 6n at 10 second intervals for example, and/or when interrogated by a mobile receiver, such as a drive-by receiver, a manually applied card, or the like.

In addition, the time periods set forth above are provided merely for purposes of example, and may be varied according to any particular application. For example, where closer monitoring of the consumption rate at the various installations is desired, the sleep state of the booster unit 20 could be less than four hours, and/or the reading intervals stored in each meter unit and transmitted to the respective booster unit could be less than 15 minutes. If necessary, the time of the active state for each booster unit could be increased, as may be necessary, to provide more consumption information to the central station.

Many other variations, modification and applications of the invention will be apparent.

What is claimed is:

1. A data collection system for collecting, at a central station, utility consumption data from a plurality of sites, comprising:
a meter unit for each site, including: a measuring device for measuring the utility consumption at the respective site; a storage device for storing the measured utility consumption during successive relatively-short time intervals; and a short-range transceiver;
a booster unit for each consumption site, including: a short-range transceiver for communication with said short-range transceiver of the meter unit at the respective site via a short-range transmission channel; and a long-range transmitter for transmitting utility consumption data to said central station via a long-range transmission channel; and
a control system periodically activating said booster unit from a relatively long sleep state, to a relatively short active state during which the booster unit: receives from its respective meter unit, via said short-range transmission channel, the utility consumption data stored therein during the preceding sleep state of the booster unit; and transmits said received utility consumption data to said central station via said long-range transmission channel.

2. The system according to claim 1, wherein the sleep state of the booster unit is many orders of magnitude larger than the active state such as to enable the use of batteries requiring less frequent replacement or recharging, while still providing the central station with utility consumption data for relatively-short time intervals to enable better tracking of the utility consumption at the various sites.

3. The system according to claim 1, wherein said long-range transmitter of said booster unit is a frequency-hopping spread-spectrum transmitter such as to reduce the possibility of interference with respect to other transmissions.

4. The system according to claim 1, wherein said short-range transceiver of said meter unit is a transponder which transmits its utility consumption data via said short-range transmission channel to said booster unit in response to an interrogating signal transmitted by said booster unit to said meter unit via said short-range transmission channel at the start of the active state of the booster unit.

5. The system according to claim 1, wherein each of said relatively-short time intervals at which the measured utility consumption is stored in the storage device is measured in minutes; and each of said sleep states of the booster unit is measured in hours.

6. The system according to claim 1, wherein each of said relatively-short time intervals at which the measured utility consumption is stored in the storage device is about 15 minutes; and each of said sleep states of the booster unit is about four hours, such that during each active state of the booster unit, it receives from the meter unit via said short-range transmission channel about 16 readings, and transmits same via said long-range transmission channel to said central station.

7. The system according to claim 1, wherein each of said meter units further includes a short-range transmitter activated at successive time intervals of very short duration for transmitting measured utility consumption data to mobile receivers via a short-range transmission channel.

8. The system according to claim 7, wherein said successive time intervals of very short duration are measured in seconds, said successive relatively-short time intervals are measured in minutes, said sleep state of the booster unit is measured in hours, and said active state of the booster unit is measured in second or fractions of a second.

9. The system according to claim 1, wherein said short-range transceiver of said meter unit is a transponder which transmits its utility consumption data via said short-range transmission channel to said booster unit, or to a mobile unit, in response to an interrogating signal transmitted by said booster unit or mobile unit to said meter unit via said short-range transmission channel.

10. The system according to claim 1, wherein each meter unit is enclosed within a housing constructed to be included in a pit hole in the ground, and each booster unit is located on a removable lid for the housing of its respective booster unit.

11. A method of collecting, at a central station, utility consumption data from a plurality of sites, comprising:
measuring the utility consumption in a meter unit at each site;
storing in said meter unit the utility consumption measured during a plurality of successive, relative-short time intervals;
and periodically activating a booster unit at the respective sit, normally in a sleep state, to an active state during which the booster unit receives from the respective meter unit, via a short-range transmission channel, the utility consumption data stored in the meter unit during the preceding sleep state of the booster unit, and transmits said received utility consumption data to said central station via said long-range transmission channel.

12. The method according to claim 11, wherein the sleep state of the booster unit is many orders of magnitude larger than the active state such as to enable the use of batteries requiring less frequent replacement or recharging, while still providing the central station with utility consumption data for relatively-short time intervals to enable better tracking of the utility consumption at the various sites.

13. The method according to claim 11, wherein said booster unit transmits said received utility consumption data to said central station via a frequency-hopping spread-spectrum transmission such as to reduce the possibility of interference with respect to other transmissions.

14. The method according to claim 11, wherein said meter unit includes a transponder which transmits its utility consumption data via said short-range transmission channel to said booster unit in response to an interrogating signal transmitted by said booster unit to said meter unit via said short-range transmission channel at the start of the active state of the booster unit.

15. The method according to claim 11, wherein each of said relatively-short time intervals during which the measured utility consumption is stored in the storage device is measured in minutes; and each of said sleep states of the booster unit is measured in hours.

16. The method according to claim 11, wherein each of said relatively-short time intervals during which the measured utility consumption is stored in the storage device is about 15 minutes; and each of said sleep states of the booster unit is about four hours, such that during each active state of the booster unit, it receives from the meter unit via said short-range transmission channel about 16 readings, and transmits same via said long-range transmission channel to said central station.

17. The method according to claim 11, wherein each of said meter units further includes a short-range transmitter activated at successive time intervals of very short duration for transmitting measured utility consumption data to mobile receivers via a short-range transmission channel.

18. The method according to claim 17, wherein said successive time intervals of very short duration are measured in seconds, said successive relatively-short time intervals are measured in minutes, said sleep state of the booster unit is measured in hours, and said active state of the booster unit is measured in seconds or fractions of a second.

19. The method according to claim 17, wherein each meter unit includes a transponder which transmits its utility consumption data via said short-range transmission channel to said booster unit, or to a mobile unit, in response to an interrogating signal transmitted by said booster unit or mobile unit to said meter unit via said short-range transmission channel.

20. The method according to claim 11, wherein each meter unit is enclosed within a housing constructed to be included in a pit hole in the ground, and each booster unit is located on a removable lid for the housing of its respective booster unit.
